(19) United States
(12) Patent Application Publication
(10) Pub. No.: US 2017/0259792 A1
(43) Pub. Date: Sep. 14, 2017

(54) AUTOMATIC WHEEL CHOCK DEVICE

(71) Applicant: BD Goods, LLC, Clermont, FL (US)

(72) Inventor: Doland Austin, Clermont, FL (US)

(21) Appl. No.: 15/066,634

(22) Filed: Mar. 10, 2016

(51) Int. Cl. B60T 3/00; B60T 7/20

(52) U.S. Cl. CPC B60T 3/00; B60T 7/20

(57) ABSTRACT

An automatic wheel chock device includes a motion unit and a mounting bracket for engaging a vehicle or trailer. The motion unit is connected to a swing arm having a wheel chock located along the distal end thereof. The motion unit transitions the swing arm between a retracted and extended position to secure the wheel chock against the vehicle tire.

### TECHNICAL FIELD

The present invention relates generally to the trucking industry, and more particularly to a device that can automatically deploy and retrieve wheel chocks on a truck or trailer.

### BACKGROUND

The statements in this section merely provide background information related to the present disclosure and may not constitute prior art.

Each year, hundreds of members of the trucking industry become injured while loading or unloading vehicles. Whether it is a tractor trailer, a flat bed or a box truck, workers are often required to physically enter the storage compartment of the vehicle to retrieve the goods being transported and delivered. With particular respect to loading docks, workers often employ forklifts and other such machinery to streamline the process.

In order to prevent injury or death, federal regulations require that the tractor trailer's wheels be immobilized during the loading and unloading process. To this end, there are many known forms of wheel chocks that are commercially available. Each of these devices function in a similar manner wherein they are wedged against the tire and/or between the tire and the pavement, in order to prevent the vehicle from moving. Although wheel chocks are extremely useful in preventing the vehicles from moving, the current art suffers from many significant drawbacks.

One significant drawback is that although regulations state wheel chocks must be used, the regulations do not state who is responsible for providing the devices. As such, when an independent truck driver delivers a trailer that is owned by a manufacturer to a location that is operated by a distributor, each party looks to the other to supply the devices. In practice, it is not uncommon for too few or no such devices to be available, thereby requiring the workers to load or unload the trailer without the mandatory safety chocks. Another common problem is that even when such devices are available and properly deployed, drivers often forget to remove them before attempting to drive away. Such a feature can result in damage to the chock, the vehicle and/or workers standing nearby.

Accordingly, the present invention is directed to an automatic wheel chock system which differs from the foregoing in a number of aspects. The manner by which will become more apparent in the description which follows, particularly when read in conjunction with the accompanying drawings.

### SUMMARY OF THE INVENTION

The present invention is directed to an automatic wheel chock device. One embodiment of the present invention can include a motion unit that can be mounted onto a vehicle or trailer. The motion unit can be connected to a swing arm having a wheel chock located along the distal end thereof. The motion unit can transition the swing arm between a retracted and extended position, wherein in the extended position the wheel chock is secured between the vehicle tire and the ground.

Another embodiment of the present invention can include a pneumatic motor that can engage a tractor-trailer air system and a switch for controlling the operation of the motor. The switch can be installed in the cab of the vehicle and can include a light to provide a visual warning to the vehicle driver when the device is in the extended position.

Yet another embodiment of the present invention can include a linear actuation motor that is connected to a straight swing arm having a pair of wheel chocks along the distal end thereof. The pair of wheel chocks can function to immobilize two vehicle tires that are positioned front to back.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of an automatic wheel chock device, in accordance with one embodiment of the invention.

FIG. 2 is a side view of a pair of automatic wheel chock devices in the extended position, in accordance with one embodiment of the invention.

FIG. 3 is a side view of a pair of automatic wheel chock devices in the retracted position, in accordance with one embodiment of the invention.

FIG. 4 is a perspective view of an automatic wheel chock device, in accordance with another embodiment of the invention.

FIG. 5 is a side view of a pair of automatic wheel chock devices in the retracted position, in accordance with the other embodiment of the invention.

FIG. 6 is a side view of a pair of automatic wheel chock devices in the extended position, in accordance with the other embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “pivotally secured” and “rotatably connected” and all derivatives shall be used interchangeably to describe a situation wherein two or more objects are joined together in a manner that allows one or both of the objects to pivot and/or rotate about or in relation to the other object. Several nonlimiting examples include traditional single hinge mechanisms, pivoting couplers and and/or swivel flanges, for example. Alternatively, or in conjunction with the above noted devices, the objects can be rotatably connected via a dual axis hinge capable of providing both rotational movement (i.e., horizontal) and pivotal movement (i.e., vertical). One suitable dual axis hinge is described in U.S. Pat. No. 7,979,960, the contents of which are incorporated herein by reference.

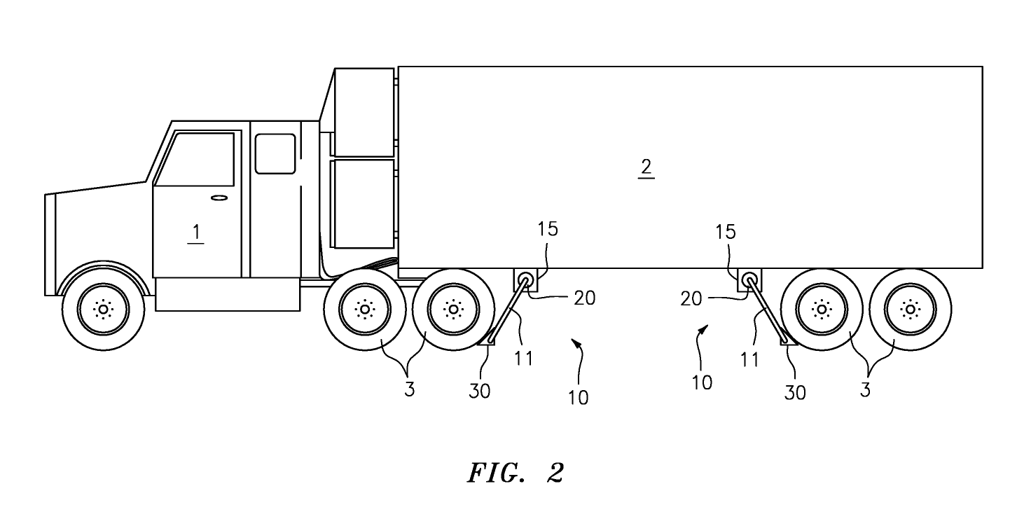

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

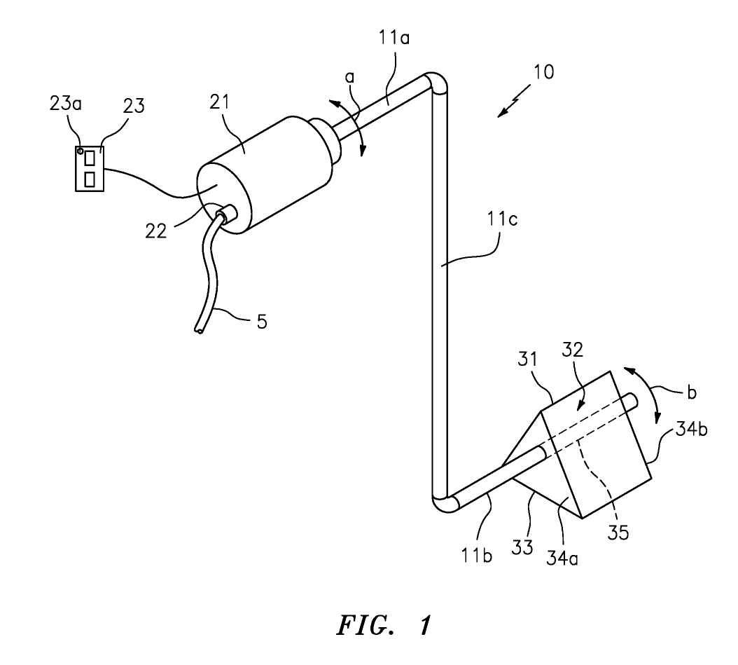

FIG. 1 illustrates one embodiment of an automatic wheel chock device 10 that is useful for understanding the inventive concepts disclosed herein. As shown, the device 10 can include a swing arm 11 that is pivotally connected to a motion unit 20 and a wheel chock 30.

In one embodiment, the swing arm 11 can include a first end 11.a that is connected to the motion unit 20, a second end 11b that is connected to the wheel chock 30, and a middle section 11c that is disposed therebetween. In the preferred embodiment, the first and second ends 11a and 11b are arranged parallel to each other, so as to extend outward from the middle section 11c in a perpendicular manner.

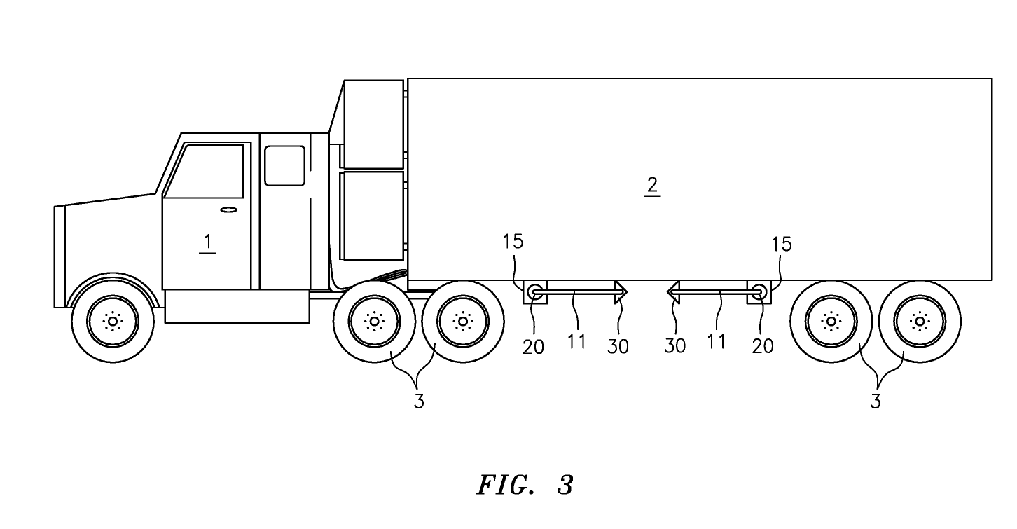

In this regard, when a rotational force (see arrow a) is applied onto the first end 11a via the motion unit 20, the second end of the arm 11b can move relative to the rotational force. Such a feature allows the arm to pivot between the stowed/retracted position shown in FIG. 3, and the extended position shown in FIG. 2. In either instance, because the arm is designed to physically wedge the chock 30 between the vehicle tire and the ground, it is preferred that the arm 11 be constructed from an extremely rigid and heavy duty material such as steel tubing, for example.

Although described with respect to a particular shape, size or material, this is for illustrative purposes to best explain the principles and operation of the device. To this end, the swing arm can include any number of different shapes, dimensions and/or construction materials suitable for performing the functionality described herein.

The motion unit 20 can function to apply a rotational force onto the swing arm 11, so as to transition the device between the extended and retracted position. In the preferred embodiment, the motion unit 20 can include a low speed high torque pneumatic motor 21 having a connector 22 for engaging an air hose 5 that is a part of the vehicles air system. The motor can be operated by a switch 23 that can be located at any suitable location such as the vehicle cab 1, for example, to operate the motor. The switch can also include a light 23a to provide a clear visual warning to the driver when the device is in the extended position.

Of course, the motion unit is not limited to a pneumatic motor that is coupled to the end of the arm 11a, as shown, as any number of other devices capable of providing the necessary movement are contemplated. To this end, the motion unit can also include or comprise any number of mechanical devices such as an AC or DC powered electric motor, and/or a hydraulic motor, for example.

Moreover, any number of linear actuators can be interposed between the arm 11 and the trailer/vehicle in any mechanical arrangement, so as to allow the wheel chock to engage and disengage the wheels, as described below. Further, although described as including a motor, other embodiments are contemplated wherein the motion unit includes or comprises a purely mechanical mechanism such as a mechanical ratcheting and pawl device, for example, which can allow a user to manually extend and retract the device via a handle, for example.

In yet another embodiment, the motion unit can include or comprise a hinge that rotatably secures the first end of the swing arm 11a to the trailer or vehicle. In this regard, the swing arm can be gravity operated when moving from the retracted to extended position. Likewise, the arm can be physically lifted by the user and secured in the retracted position via a clip or other form of retention device.

In one embodiment, the wheel chock 30 can include an elongated, generally triangular shaped member having a thin leading edge 31, a tapered middle section 32, a thick trailing end 33, and a pair of sides 34a and 34b. The chock can be constructed to include a length (i.e., distance between sides 34a and 34h) of between approximately 12 and 36 inches, for example, so as to be able to accommodate either a single wheel or a dual wheel (side by side) arrangement. In the preferred embodiment, the wheel chock can further include a central channel 35 into which the second arm of the swing arm 11b can be positioned. Such a feature can allow the wheel chock to rotate (see arrow b) about the central axis of the swing arm section 11b.

The wheel chock 30 can be constructed from any number of different materials such as various metals, plastics and the like. The outer surface of the wheel chock can preferably be coated with a high friction material such as rubber, for example, or can include a plurality of ridges to impart greater friction.

Although described above with respect to a particular shape or construction material, this is for illustrative purposes, as the wheel chock 30 can include or comprise any number of different shapes and sizes, and can be constructed from any number of different construction materials. Moreover, other embodiments are contemplated wherein the chock 30 can be fixedly or hingedly secured to the end of the swing arm 11b, in accordance with known construction methodologies.

FIGS. 2 and 3 illustrate one embodiment of the automatic wheel chock device 10 in the extended and retracted position, respectively. The present example highlights the preferred deployment wherein two devices 10 will be utilized simultaneously to engage the trailer tires 3, thereby preventing motion in both the forward and backward direction. Of course, two devices are not required, as a single device 10 can also be installed as shown to prevent movement in a single direction. Moreover, although shown as being mounted along the center portion of the trailer 2, this is for illustrative purposes only, as various embodiments of the device 10 can be constructed and installed along any portion of the vehicle 1 and/or trailer 2, without limitation.

In either case, the device 10 can be mounted on the mounting bracket 15 onto the vehicle 1 and/or trailer 2 at a location suitable to allow the chock 30 to engage the tires 3, as shown. As described herein, the mounting bracket 15 can preferably be constructed from hardened steel, and can function as a housing that is capable of securing the device 10 onto the body of the vehicle 1 or trailer 2. When so mounted, the motion unit 20 of each installed device can be activated via the switch 23 to transition between the extended and retracted positions, thereby immobilizing and allowing movement of the vehicle, respectively.

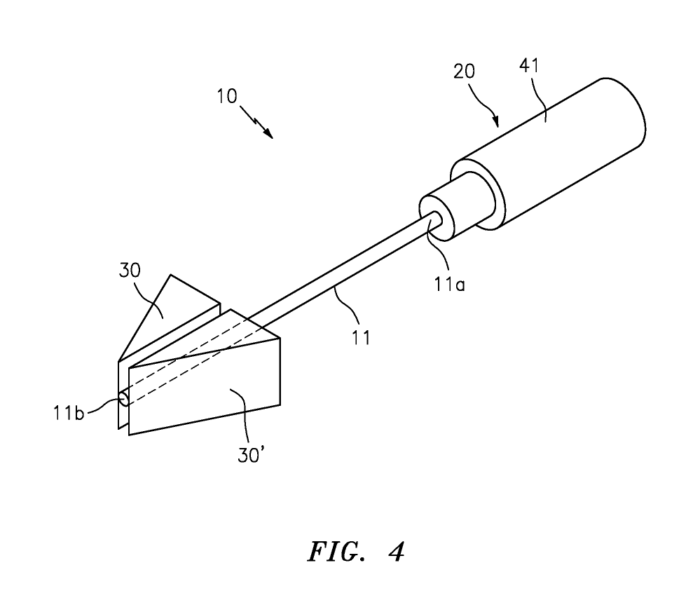

FIG. 4 illustrates another embodiment of the automatic wheel chock device 10, that is configured to simultaneously engage two wheels that are arranged front to back at a single time. As shown, the device of the present embodiment can include a motion unit 20 comprising a linear actuated motor 41, a swing arm 11 having a rigid straight shape, and a pair of triangular-shaped wheel chocks 30 and 30′ that are mounted along the distal end 11b of the swing arm.

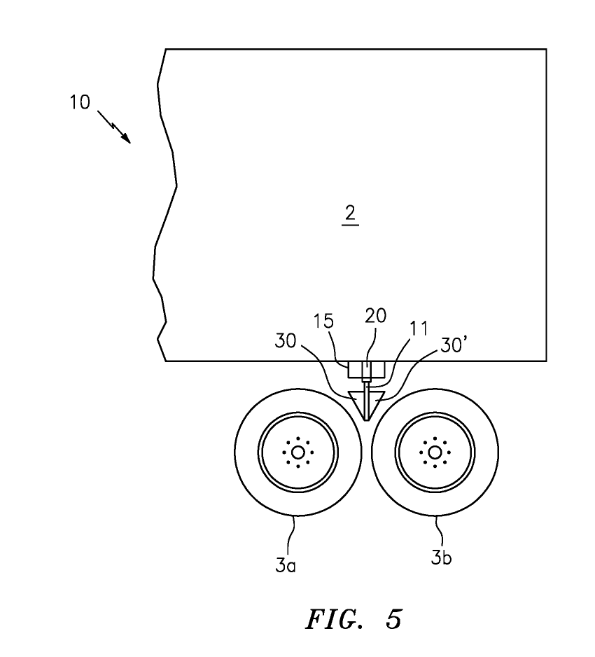

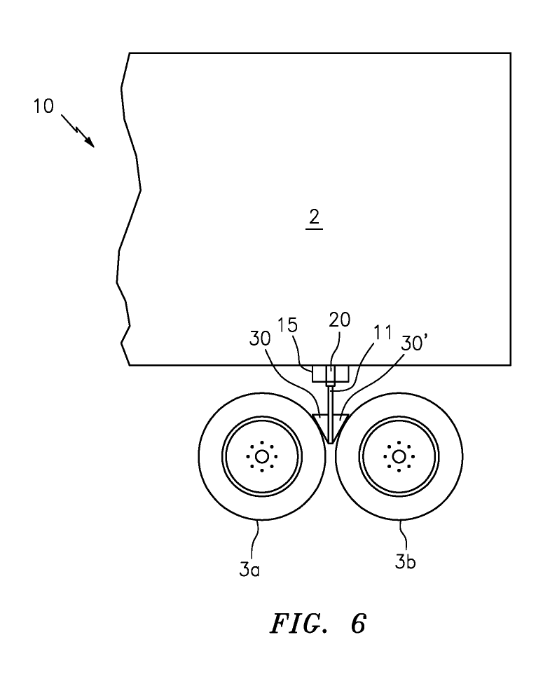

FIGS. 5 and 6, illustrate the automatic wheel chock device 10 in the extended and retracted position, respectively. As shown, the device 10 can be mounted on the mounting bracket 15 onto the vehicle 1 and/or trailer 2 at a location directly above and between two wheels 3a and 3b that are arranged in a front to back direction. When so mounted, the motion unit 20 can be activated via the switch 23 to extend the wheel chocks 30 and 30′ until they are in contact with both of the wheels 3a and 3b, thereby allowing a single device to prevent forward and backward motion of the vehicle when extended. Finally, when the vehicle is ready to move, the motion unit 20 can retract the wheel chocks, thereby allowing free movement of the tires 3a and 3b.

As described herein, one or more elements of the automatic wheel chock device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements such as the swing arm 11 and the wheel chock 30, for example, may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An automatic wheel chock device for use on a vehicle having a body and at least one wheel, said wheel chock device comprising:
a rigid swing arm having a first end, a second end and a middle section;
a wheel chock that is connected to the second end of the rigid swing arm; and
a motion unit that is connected to the first end of the rigid swing arm, said motion unit being configured to transition the swing arm between an extended position and a retracted position.

2. The device of claim 1, wherein the motion unit includes a motor that is configured to generate and apply mechanical force onto the swing arm.

3. The device of claim 2, wherein the motor comprises:
a pneumatic motor having a connector for engaging an air hose of the vehicle onto which the motor is secured.

4. The device of claim 1, wherein the swing arm is constructed from an elongated steel rod.

5. The device of claim 1, wherein the wheel chock is pivotally secured onto the second end of the swing arm.

6. The device of claim 1, wherein the wheel chock includes a generally triangular shape having a thin leading edge, a tapered middle portion and a thick trailing edge.

7. The device of claim 1, further comprising:
a mounting bracket that is configured to secure the motion unit onto the body of the vehicle at a location suitable for allowing the wheel chock to engage the at least one wheel when in the extended position, and to disengage the at least one wheel when in the retracted position.

8. An automatic wheel chock device for use on a vehicle having a body and at least two wheels, said wheel chock device comprising:
a rigid swing arm having a first end, a second end and a middle section;
a pair of wheel chocks that are connected to the second end of the rigid swing arm; and
a motion unit that is connected to the first end of the rigid swing arm, said motion unit being configured to transition the swing arm between an extended position and a retracted position.

9. The device of claim 8, wherein the motion unit includes a motor that is configured to generate and apply mechanical force onto the swing arm.

10. The device of claim 9, wherein the motor comprises:
a linear actuation motor that is configured to extend and retract the swing bar in a linear fashion.

11. The device of claim 8, wherein the swing arm is constructed from an elongated straight steel rod.

12. The device of claim 8, wherein each of the wheel chocks are rigidly secured onto the second end of the swing arm.

13. The device of claim 8, wherein each of the wheel chocks include a generally triangular shape having a thin leading edge, a tapered middle portion and a thick trailing edge.

14. The device of claim 8, further comprising:
a mounting bracket that is configured to secure the motion unit onto the body of the vehicle at a location directly above and between the two wheels,
wherein the pair of wheel chocks are configured to engage both wheels when in the extended position, and to disengage both wheels when in the retracted position.
